(19) United States
(12) Patent Application Publication
(10) Pub. No.: US 2025/0159527 A1
(43) Pub. Date: May 15, 2025

(54) METHOD AND APPARATUS FOR SATELLITE ACCESS NETWORK MEASUREMENT OUTSIDE GAPS

(71) Applicant: MEDIATEK INC., Hsinchu City (TW)

(72) Inventor: Hsuan-Li LIN, Hsinchu City (TW)

(21) Appl. No.: 18/837,425

(22) PCT Filed: Feb. 10, 2023
(86) PCT No.: PCT/CN2023/075351

§ 371 Date: Aug. 9, 2024

Related U.S. Application Data
(60) Provisional application No. 63/316,006, filed on Mar. 3, 2022.

(51) Int. Cl. H04W 24/10; H04W 8/24; H04W 24/02; H04W 84/06

(52) U.S. Cl. CPC H04W 24/10; H04W 8/24; H04W 24/02; H04W 84/06

(57) ABSTRACT

Various solutions for satellite access network (SAN) or non-terrestrial network (NTN) measurement outside gaps with respect to user equipment and network apparatus in mobile communications are described. An apparatus may determine whether a measurement gap is needed for performing an NTN inter-frequency measurement. The apparatus may determine whether a data interruption is needed for performing the NTN inter-frequency measurement in an event that the measurement gap is not needed. The apparatus may report a user equipment capability to a network node according to a determination result.

### CROSS REFERENCE TO RELATED PATENT APPLICATION(S)

The present disclosure claims the priority benefit of U.S. Provisional Patent Application No. 63/316,006, filed on 3 Mar. 2022. The contents of aforementioned applications are herein incorporated by reference in their entirety.

### TECHNICAL FIELD

The present disclosure is generally related to mobile communications and, more particularly, to satellite access network (SAN) or non-terrestrial network (NTN) measurement outside gaps with respect to user equipment (UE) and network apparatus in mobile communications.

### BACKGROUND

Unless otherwise indicated herein, approaches described in this section are not prior art to the claims listed below and are not admitted as prior art by inclusion in this section.

In mobile/wireless communications, more and more attentions and participation were drawn into satellite communications, with companies and organizations convinced of the market potential for an integrated satellite and terrestrial network infrastructure in the context of 3rd Generation Partnership Project (3GPP) 5G standards. Satellites refer to spaceborne vehicles in Low Earth Orbits (LEO), Medium Earth Orbits (MEO), Geostationary Earth Orbit (GEO) or in Highly Elliptical Orbits (HEO). 5G standards make Non-Terrestrial Networks (NTN), including satellite segments, a recognized part of 3GPP 5G connectivity infrastructure. A low earth orbit is an earth-centered orbit with an altitude of 2,000 km or less, or with a period of 128 minutes or less (i.e., making at least 11.25 orbits per day) and an eccentricity less than 0.25. Most of the artificial objects in outer space are in non-geostationary satellite orbit (NGSO) (e.g., LEO or MEO) with an altitude never more than about one-third of the radius of earth. NGSO satellites orbit around the earth at a high speed (mobility), but over a predictable or deterministic orbit.

One of the challenges in NGSO communications is that the Doppler shift is huge since the NGSO satellites move at a high speed. The Doppler shift of a LEO-600 km network can be up to 24 parts per million (ppm). For example, in the 2 gigahertz (GHz) carrier, the maximum Doppler shift of a LEO satellite can be up to +/−48 kilohertz (kHz). Therefore, satellite/cell measurements in NGSO satellite-based NTN can be quite different from terrestrial networks. In terrestrial networks, cells/base stations are well synchronized in frequency and the Doppler shifts among cells/base stations are minor. No need to consider Doppler effect when performing measurements. However, in NTN or SAN, Doppler effect is significant and Doppler shifts among satellites/cells are large. This will cause additional burdens on the UE in processing frequency/time drifts when performing satellite/cell measurements. The capability/cost requirements including hardware and software for the UE will become more complex and expensive.

Accordingly, how to overcome large Doppler shifts becomes an important issue for satellite communications in the newly developed wireless communication network. Therefore, there is a need to provide proper schemes to perform satellite/cell measurements without increasing UE burdens and requirements.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to SAN or NTN measurement outside gaps with respect to user equipment and network apparatus in mobile communications.

In one aspect, a method may involve an apparatus determining whether a measurement gap is needed for performing an NTN inter-frequency measurement. The method may also involve the apparatus determining whether a data interruption is needed for performing the NTN inter-frequency measurement in an event that the measurement gap is not needed. The method may further involve the apparatus reporting a UE capability to a network node according to a determination result.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising determining whether a measurement gap is needed for performing an NTN inter-frequency measurement. The processor may also perform operations comprising determining whether a data interruption is needed for performing the NTN inter-frequency measurement in an event that the measurement gap is not needed. The processor may further perform operations comprising reporting, via the transceiver, a UE capability to the network node according to a determination result.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to SAN or NTN measurement outside gaps with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

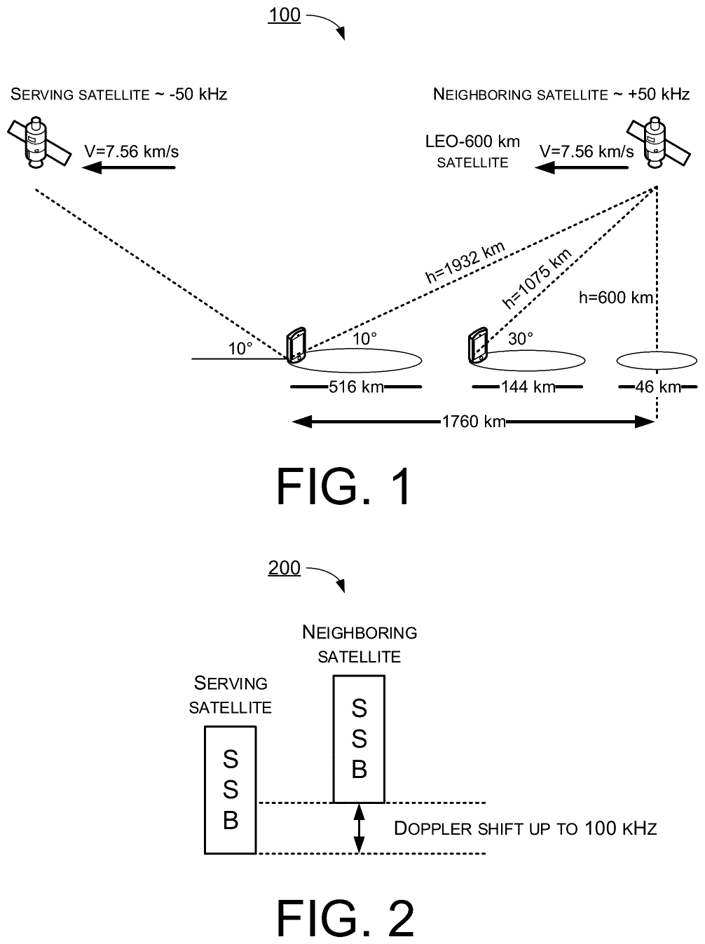

According to the reference scenario parameters of Table 4.2-2 in 3GPP TR 38.821, the maximum Doppler shift of a LEO-600 km network can be up to 24 ppm. In addition, the Doppler of a serving satellite and a neighboring satellite may be with different signs (e.g., the serving satellite is leaving the UE while the neighboring cell is approaching to the UE). FIG. 1 illustrates an example scenario 100 under schemes in accordance with implementations of the present disclosure. Scenario 100 involves at least one UE and a plurality of network nodes (e.g., satellites), which may be a part of a wireless communication network (e.g., an LTE network, a 5G/NR network, an IoT network or a 6G network). As shown in FIG. 1, the satellites are deployed in LEO or NGSO and orbit around the earth at a high speed. The UE on the ground needs to connect to a serving satellite for SAN or NTN communications. The UE may also need to perform some measurements on a neighboring satellite for mobility management. Under scenario 100, the UE is located between two satellites. Thus, the serving satellite is leaving the UE and the neighboring cell is approaching to the UE. The Doppler shift will become large/significant under such situation. For example, the Doppler shift of the serving satellite observed at the UE could be −50 kHz whereas the Doppler shift of the neighboring satellite observed at the UE could be +50 kHz. It leads up to around 100 kHz frequency separation between the serving satellite and the neighboring satellite.

FIG. 2 illustrates an example scenario 200 under schemes in accordance with implementations of the present disclosure. The Doppler shift between the reference signals (e.g., Synchronization Signal Block (SSB)) from the serving satellite and the neighboring satellite at 2 GHz can be up to 100 kHz. In other words, if two satellites are configured in one measurement object (MO) with the same absolute radio frequency channel number (ARFCN), up to 100 kHz Doppler shift can be observed. Therefore, extra hardware would be needed to receive/measure on different satellites. For example, the UE may need to be equipped with two transceivers to perform measurements on the neighboring satellite while connecting to the serving satellite. Additional hardware/software costs may be also needed for measuring/communicating with the two satellites at the same time.

In SAN or NTN, a measurement gap (MG) could be configured to the UE for performing an SAN/NTN inter-frequency measurement for a neighboring/target satellite. The UE can perform the measurement within the measurement gap. However, in some scenarios, no measurement gap is configured or applicable for measurement. For example, due to the Doppler effect in NGSO, the cell timing of the neighboring/target satellite could drift/change. Therefore, the timing of the reference signal (e.g., SSB) from the neighboring/target satellite may be changed/drifted. The original configured measurement gap becomes inapplicable or invalid. Under the scenario that no measurement gap is configured or applicable, the UE may need to perform the measurement outside the measurement gap. However, when performing the measurement, the UE may be not able to perform data transmission or data reception at the same time. A data interruption may occur during the measurement that may affect quality of services. Thus, some solutions are needed for performing SAN/NTN inter-frequency measurement outside the measurement gaps.

In view of the above, the present disclosure proposes several schemes pertaining to measurements outside gaps with respect to UE and network apparatus in SAN or NTN. According to the schemes of the present disclosure, when no measurement gap is configured or applicable, the UE may automatously perform the inter-frequency measurement outside the gaps. Since the data interruption may occur during the measurement, the UE needs to determine a data interruption period. The data interruption period should be allowed for the UE and the network side. The UE may determine the data interruption period based on position/duration of a configured SSB measurement timing configuration (SMTC). Alternatively, the UE may determine the data interruption period based on position/duration of an SSB from the neighboring/target satellite. After determining the data interruption period, the UE may perform the measurement within the data interruption period. The data interruption is allowed/permitted by the network node. Accordingly, the UE is able to support SAN/NTN measurements for neighboring/target cells/satellites (e.g., NGSO satellites) and mobility performance without significant decrease in data transmission performance or quality of services. Some balances can be reached between mobility performance and data transmission performance.

Specifically, the UE may be configured to indicate/report UE capability for the SAN/NTN inter-frequency measurement object. The UE may determine whether a measurement gap is needed for performing the SAN/NTN inter-frequency measurement. The determination may be based on UE capability. For example, in a case that the UE is equipped with two transceivers which can perform measurement and data reception/transmission simultaneously, the UE may not need the measurement gap. The UE may further determine whether a data interruption is needed for performing the NTN inter-frequency measurement in an event that the measurement gap is not needed. Then, the UE may report a UE capability to the network node according to the determination result. The UE capability may be reported/indicated per-band (e.g., frequency band) or per-UE (e.g., UE-specific).

In an event that the UE indicates/reports the measurement gap is not needed, the UE may be able to perform the inter-frequency measurement outside the measurement gaps with a determined measurement period. For example, the UE may automatously perform the inter-frequency measurement outside the gaps if the target cell's timing is drifting away from the gap. Specifically, the UE may receive a configuration of the measurement gap. Since the target satellite moves at a high speed, the timing of the target satellite may drift after a period of time. The network node may not update the measurement gap frequently. The SSB from the target satellite may drift away from the configured measurement gap after the period of time. Thus, the UE may determine/detect that a cell timing (e.g., downlink timing) of a target satellite is drifted away from the measurement gap. Under such situation, the received measurement gap configuration is not applicable. Instead of using the measurement gap, the UE may automatously perform the inter-frequency measurement outside the configured gaps. The UE may determine a data interruption period outside the measurement gap. The UE may perform the NTN inter-frequency measurement within the data interruption period.

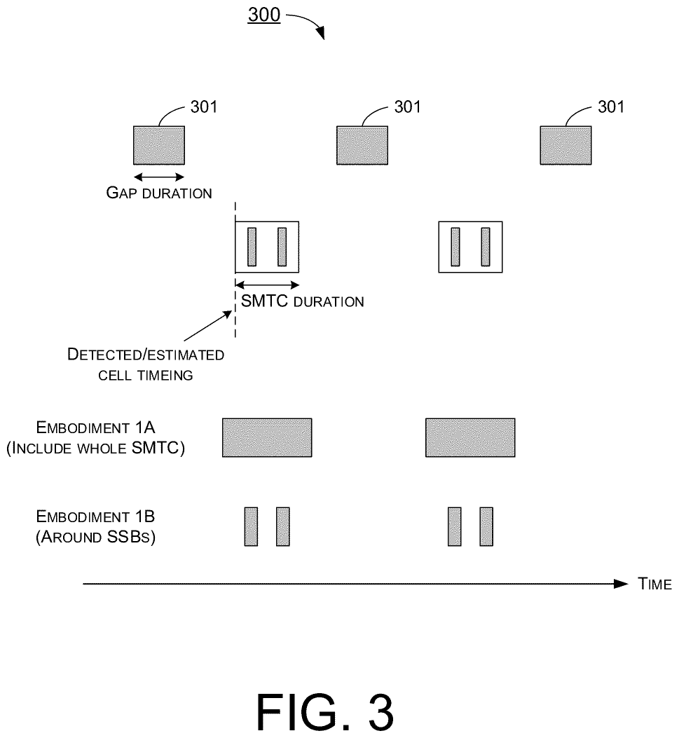

FIG. 3 illustrates an example scenario 300 under schemes in accordance with implementations of the present disclosure. Scenario 300 involves at least one UE and a plurality of network nodes (e.g., satellites), which may be a part of a wireless communication network (e.g., an LTE network, a 5G/NR network, an IoT network or a 6G network). Scenario 300 illustrates some embodiments of data interruption period determined by the UE. The UE may receive a configuration of measurement gap 301 with a gap duration and position. The UE may detect/estimate that the cell timing of the target cell is drifted away from measurement gap 301 according to the ephemeris information received from the target satellite. Then, the UE needs to determine an interruption period outside measurement gap 301 for performing the inter-frequency measurement for the target satellite.

In embodiment 1A, the UE may determine the interruption period based on the SMTC. Specifically, the UE may receive a configuration of SMTC with a SMTC duration for the target satellite. The UE may determine the data interruption period according to the configured SMTC duration. For example, the UE may determine the data interruption period to include the whole SMTC duration or part of the SMTC duration. The data interruption period may be longer or shorter than the SMTC duration. The data interruption period may be around the SMTC or comprise the SMTC. The UE may determine the data interruption period according to its capability and implementation.

In embodiment 1B, the UE may determine the interruption period based on the SSB. Specifically, the UE may receive a configuration of SSB of the target satellite. The UE may determine the data interruption period according to the position and duration of SSB. For example, the UE may determine the data interruption period to include the SSB duration (e.g., around the SSB) of the target satellite. The data interruption period may be longer than the SSB duration and shorter than the SMTC duration. The UE may determine multiple separated data interruption periods for multiple SSBs. Accordingly, the data interruption period could be short and will not cause too many interruptions on data transmission/reception.

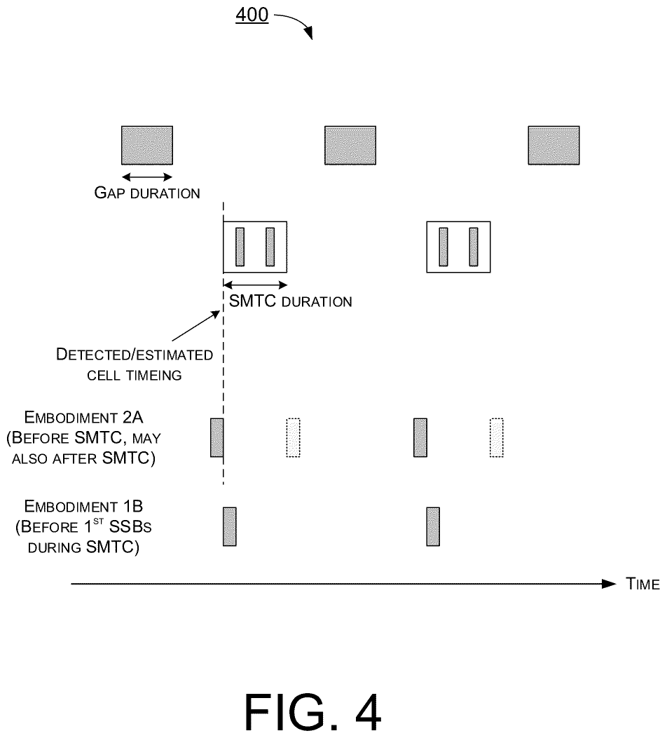

FIG. 4 illustrates an example scenario 400 under schemes in accordance with implementations of the present disclosure. Scenario 400 involves at least one UE and a plurality of network nodes (e.g., satellites), which may be a part of a wireless communication network (e.g., an LTE network, a 5G/NR network, an IoT network or a 6G network). Scenario 400 illustrates some embodiments of data interruption period determined by the UE. The UE may be equipped with better hardware/software capability. For example, the UE may have two receivers and be able to perform measurement and data transmission/reception simultaneous. Thus, the UE may not need a long data interruption period for performing the inter-frequency measurement. However, the UE may need to switch its transceiver (e.g., radio frequency (RF) front-end circuit) to the target satellite for measurement. Such switching may take some time and may cause interferences on the other transceiver. Thus, a short data interruption period is still needed for performing the switching.

In embodiment 2A, the UE may determine the interruption period based on the SMTC. Specifically, the UE may receive a configuration of SMTC with a SMTC duration for the target satellite. The UE may determine the data interruption period according to the configured SMTC duration. For example, the UE may determine the data interruption period before the start of the SMTC duration. The data interruption period may be short or just for the switching time of the transceiver. The UE may switch to the target satellite during the data interruption period for performing the NTN inter-frequency measurement. The data interruption period may be before the SMTC and/or after the SMTC. The UE may need to switch back to the serving satellite after the measurement. Thus, a data interruption period after the SMTC may be reserved for switching back. The UE may determine the data interruption period according to its capability and implementation.

In embodiment 2B, the UE may determine the interruption period based on the SSB. Specifically, the UE may receive a configuration of SSB of the target satellite. The UE may determine the data interruption period according to the position and duration of SSB. For example, the UE may determine that the data interruption period is before the first SSB during the SMTC of target satellite. The data interruption period may be longer than the first SSB duration and shorter than the SMTC duration. The UE may determine multiple separated data interruption periods for multiple SSBs. Accordingly, the data interruption period could be short and will not cause too many interruptions on data transmission/reception.

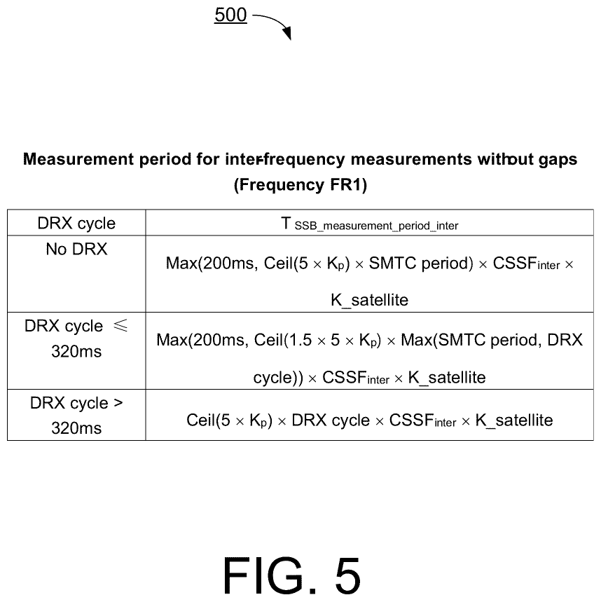

FIG. 5 illustrates an example scenario 500 under schemes in accordance with implementations of the present disclosure. Scenario 500 involves at least one UE and a plurality of network nodes (e.g., satellites), which may be a part of a wireless communication network (e.g., an LTE network, a 5G/NR network, an IoT network or a 6G network). The satellites are deployed in NGSO and orbit around the earth at a high speed. The UE on the ground connects to a serving satellite for SAN or NTN communications. The UE needs to perform measurements on a neighboring satellite for mobility management. At first, the UE may receive a first ephemeris of the serving satellite and a second ephemeris of the neighboring satellite. The UE may further receive a measurement gap configuration (e.g., measurement objects) from the serving satellite. Then, the UE needs to determine whether to perform a measurement outside the measurement gap for the neighboring satellite by determining whether the serving satellite and the neighboring satellite are different satellites. The neighboring satellite measurement may be an inter-frequency measurement.

Once the UE determines that it needs to perform the neighboring satellite measurement, it may determine a measurement period for the measurement. Scenario 500 shows the measurement period for inter-frequency measurements without gaps for frequency range 1 (FR1). The UE may determine the measurement period (e.g., T_{SSB_measurement_period_inter}) according to the equations in scenario 500. For example, different equations may be used for different DRX cycles (e.g., no DRX, DRX cycle≤320 ms or DRX cycle>320 ms). These equations may consider the parameters comprising, for example but not limited to, measurement gap repetition period (MGRP), SMTC period, carrier specific scaling factor (CSSF), DRX cycle, etc.

### Illustrative Implementations

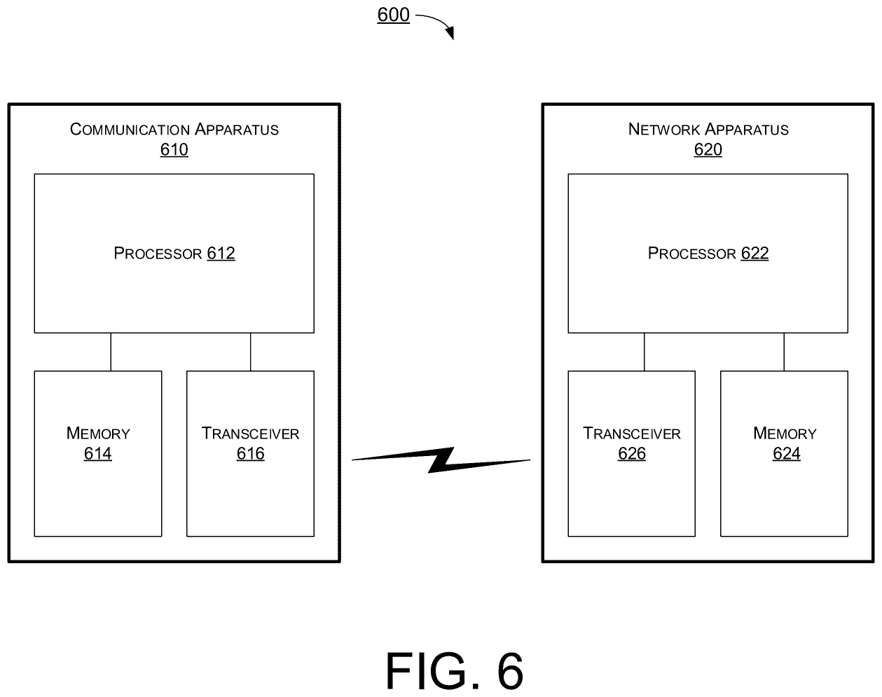

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to SAN or NTN measurement outside gaps with respect to user equipment and network apparatus in mobile communications, including scenarios/schemes described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIOT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including autonomous reliability enhancements in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, processor 612 may determine whether a measurement gap is needed for performing an NTN inter-frequency measurement. Processor 612 may determine whether a data interruption is needed for performing the NTN inter-frequency measurement in an event that the measurement gap is not needed. Processor 612 may report, via transceiver 616, a UE capability to network apparatus 620 according to a determination result. The UE capability may be reported per-band or per-UE.

In some implementations, processor 612 may perform, via transceiver 616, the NTN inter-frequency measurement outside the measurement gap in an event that the measurement gap is not needed.

In some implementations, processor 612 may receiving, via transceiver 616, a configuration of the measurement gap. Processor 612 may determine that a cell timing of a target satellite is drifted away from the measurement gap. Processor 612 may determine a data interruption period outside the measurement gap. Processor 612 may perform, via transceiver 616, the NTN inter-frequency measurement within the data interruption period.

In some implementations, processor 612 may receiving, via transceiver 616, an SMTC of the target satellite. Processor 612 may determine the data interruption period according to the SMTC.

In some implementations, the data interruption period may be around the SMTC, before the SMTC, after the SMTC or comprises the SMTC.

In some implementations, processor 612 may receiving, via transceiver 616, a configuration of SSB of the target satellite. Processor 612 may determine the data interruption period according to the SSB.

In some implementations, the data interruption period may be before a first SSB.

In some implementations, processor 612 may determine the data interruption period according to the UE capability.

In some implementations, processor 612 may switching, via transceiver 616, to the target cell during the data interruption period for performing the NTN inter-frequency measurement.

### Illustrative Processes

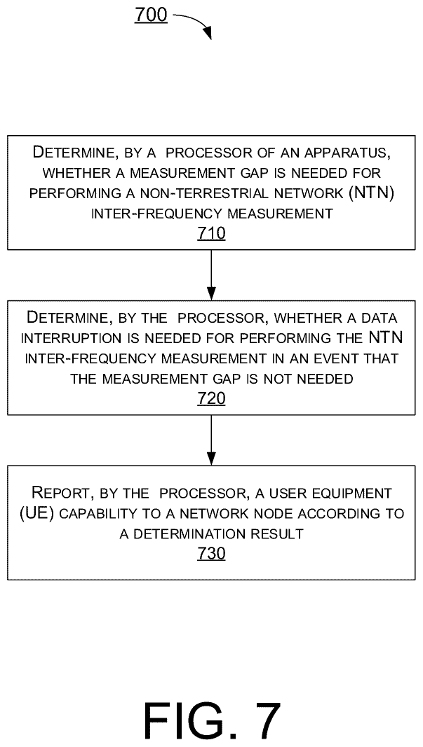

FIG. 7 illustrates an example process 700 in accordance with an implementation of the present disclosure. Process 700 may be an example implementation of above scenarios/schemes, whether partially or completely, with respect to SAN or NTN measurement outside gaps with the present disclosure. Process 700 may represent an aspect of implementation of features of communication apparatus 610. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of communication apparatus 610 determining whether a measurement gap is needed for performing an NTN inter-frequency measurement. Process 700 may proceed from 710 to 720.

At 720, process 700 may involve processor 612 determining whether a data interruption is needed for performing the NTN inter-frequency measurement in an event that the measurement gap is not needed. Process 700 may proceed from 720 to 730.

At 730, process 700 may involve processor 612 reporting a UE capability to a network node according to a determination result. The UE capability may be reported per-band or per-UE.

In some implementations, process 700 may further involve processor 612 performing the NTN inter-frequency measurement outside the measurement gap in an event that the measurement gap is not needed.

In some implementations, process 700 may further involve processor 612 receiving a configuration of the measurement gap. Process 700 may further involve processor 612 determining that a cell timing of a target satellite is drifted away from the measurement gap. Process 700 may further involve processor 612 determining a data interruption period outside the measurement gap. Process 700 may further involve processor 612 performing the NTN inter-frequency measurement within the data interruption period.

In some implementations, process 700 may further involve processor 612 receiving an SMTC of the target satellite and determining the data interruption period according to the SMTC.

In some implementations, process 700 may further involve processor 612 receiving an SSB of the target satellite and determining the data interruption period according to the SSB.

In some implementations, process 700 may further involve processor 612 determining the data interruption period according to the UE capability.

In some implementations, process 700 may further involve processor 612 switching to the target cell during the data interruption period for performing the NTN inter-frequency measurement.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether a measurement gap is needed for performing a non-terrestrial network (NTN) inter-frequency measurement;
determining, by the processor, whether a data interruption is needed for performing the NTN inter-frequency measurement in an event that the measurement gap is not needed; and
reporting, by the processor, a user equipment (UE) capability to a network node according to a determination result.

2. The method of claim 1, wherein the UE capability is reported per-band or per-UE.

3. The method of claim 1, further comprising:
performing, by the processor, the NTN inter-frequency measurement outside the measurement gap in an event that the measurement gap is not needed.

4. The method of claim 1, further comprising:
receiving, by the processor, a configuration of the measurement gap;
determining, by the processor, that a cell timing of a target satellite is drifted away from the measurement gap;
determining, by the processor, a data interruption period outside the measurement gap; and
performing, by the processor, the NTN inter-frequency measurement within the data interruption period.

5. The method of claim 4, further comprising:
receiving, by the processor, a synchronization signal block (SSB) measurement timing configuration (SMTC) of the target satellite; and
determining, by the processor, the data interruption period according to the SMTC.

6. The method of claim 5, wherein the data interruption period is around the SMTC, before the SMTC, after the SMTC or comprises the SMTC.

7. The method of claim 4, further comprising:
receiving, by the processor, a configuration of synchronization signal block (SSB) of the target satellite; and
determining, by the processor, the data interruption period according to the SSB.

8. The method of claim 7, wherein the data interruption period is before a first SSB.

9. The method of claim 4, further comprising:
determining, by the processor, the data interruption period according to the UE capability.

10. The method of claim 4, further comprising:
switching, by the processor, to the target cell during the data interruption period for performing the NTN inter-frequency measurement.

11. An apparatus, comprising:
a transceiver which, during operation, wirelessly communicates with at least one network node of a wireless network; and
a processor communicatively coupled to the transceiver such that, during operation, the processor performs operations comprising:
determining whether a measurement gap is needed for performing a non-terrestrial network (NTN) inter-frequency measurement;
determining whether a data interruption is needed for performing the NTN inter-frequency measurement in an event that the measurement gap is not needed; and
reporting, via the transceiver, a user equipment (UE) capability to the network node according to a determination result.

12. The apparatus of claim 11, wherein the UE capability is reported per-band or per-UE.

13. The apparatus of claim 11, wherein, during operation, the processor further performs operations comprising:
performing, via the transceiver, the NTN inter-frequency measurement outside the measurement gap in an event that the measurement gap is not needed.

14. The apparatus of claim 11, wherein, during operation, the processor further performs operations comprising:
receiving, via the transceiver, a configuration of the measurement gap;
determining that a cell timing of a target satellite is drifted away from the measurement gap; and
determining a data interruption period outside the measurement gap; and
performing, via the transceiver, the NTN inter-frequency measurement within the data interruption period.

15. The apparatus of claim 14, wherein, during operation, the processor further performs operations comprising:
receiving, via the transceiver, a synchronization signal block (SSB) measurement timing configuration (SMTC) of the target satellite; and
determining the data interruption period according to the SMTC.

16. The apparatus of claim 15, wherein the data interruption period is around the SMTC, before the SMTC, after the SMTC or comprises the SMTC.

17. The apparatus of claim 14, wherein, during operation, the processor further performs operations comprising:
receiving, via the transceiver, a configuration of synchronization signal block (SSB) of the target satellite; and
determining the data interruption period according to the SSB.

18. The apparatus of claim 17, wherein the data interruption period is before a first SSB.

19. The apparatus of claim 14, wherein, during operation, the processor further performs operations comprising:
determining the data interruption period according to the UE capability.

20. The apparatus of claim 14, wherein, during operation, the processor further performs operations comprising:
switching, via the transceiver, to the target cell during the data interruption period for performing the NTN inter-frequency measurement.
